(19) United States
(12) Patent Application Publication
(10) Pub. No.: US 2014/0014009 A1
(43) Pub. Date: Jan. 16, 2014

(54) Hanging Jewelry Safe Disguised as a Garment Bag

(71) Applicant: Mesheiah Crockwell, Southampton (BM)

(72) Inventor: Mesheiah Crockwell, Southampton (BM)

(21) Appl. No.: 13/904,819

(22) Filed: May 29, 2013

Related U.S. Application Data
(60) Provisional application No. 61/672,266, filed on Jul. 16, 2012.

(51) Int. Cl. E05G 1/06

(52) U.S. Cl. CPC E05G 1/06
USPC 109/53; 29/428

(57) ABSTRACT

A hanging jewelry safe is disclosed that is disguised as a garment bag that can hang from and be secured to a closet rod. The hanging jewelry safe has loops, pouches, and/or pockets inside for holding jewelry and/or other valuable items. The hanging jewelry safe can be hung on and anchored to a closet rod in a folded, zipped, and locked configuration, and can be unlocked, unzipped, and unfolded into a double hanging arrangement for easy loading and unloading of jewelry and/or other valuables. The hanging jewelry safe maintains jewelry and/or other valuables in a substantially secured state, because the safe can be locked, anchored to a closet rod, and disguised due to its resemblance to a garment bag that appears to contain garments instead of jewelry and/or other valuables.

### CROSS-REFERENCE TO RELATED APPLICATION

This application is based on the provisional application Ser. No. 61/672,266 filed Jul. 16, 2012, the entire contents of which is herein incorporated by reference, in its entirety.

### FIELD OF THE INVENTION

This invention relates generally to safes, and particularly to safes that are disguised as something else.

### BACKGROUND

Conventionally, there are a number of ways to store and protect jewelry and other valuables. Some, such as jewelry boxes, or racks kept on dresser tops, or other readily accessible locations, are very convenient but are easily noticed and are often the first targets of thieves. Others, such as conventional safes, lockboxes, etc. are more secure, but attract undue attention, and are less convenient when retrieval of the jewelry or other items is desired. There are also small items for holding valuables, which appear to have other functions, so that thieves may tend to overlook them while searching for valuables. These include, for instance, hollowed out books or other items that appear to be common objects like soda cans, electric wall outlets, or product dispensers, but may actually be used to hold valuable items. However, these generally are not ideal for various reasons, including insufficient convenience, inconvenient security, and inability to hold enough valuables. Another problem with many of these items is that they appear to have little commercial value in themselves, so that they may be easily and perhaps accidentally discarded by housekeepers, spouses, children, or even absentmindedly by their owners.

### SUMMARY

A hanging jewelry safe disguised as a garment bag is disclosed and claimed which is large enough to hold a sizeable quantity of jewelry and/or other valuable items, which is also very convenient in day-to-day use so as to facilitate storage and retrieval of the jewelry, yet does not appear to be a place where valuables are stored, and does not look like something to be discarded even when empty, and nevertheless provides real security against thieves.

A general aspect of the invention is a hanging jewelry safe for storing valuables. The hanging jewelry safe includes: a storage section substantially similar in appearance to a conventional garment bag, the storage section including a first storage side and a second storage side, the first storage side and second storage side being connected in bi-folded relationship such that from a folded, zipped, and locked configuration, the storage section can be unlocked, unzipped, and unfolded into an opened configuration so as to reveal the contents of each storage side; and a hook section, securely attached to the storage section, the hook section being capable of hanging from a closet rod, and being lockable onto the closet rod so as to prevent removal of the hook section from the closet rod when the hook section is locked.

In some embodiments, the storage section includes at least one of: pockets, pouches, and loops for storing jewelry and other valuables. In some embodiments, the second storage side includes: a hook for supporting the second storage side from the closet rod when the storage section has been unfolded into the opened configuration. In further embodiments, the hook is rotatably coupled to the second storage side such that it is rotatable about two axes.

In some embodiments, the hook section that is securely attached to the storage section is also rotatably attached to the storage section.

In some embodiments, the hook section includes: a locking device capable of locking the hook section closed so that the hook section cannot be easily removed from the closet rod without use of a key or combination. In further embodiments, the locking device includes a hinged locking plate having a lockable post, and a post access slot through the hook section for receiving the lockable post, the lockable post having a lock hole through which a lock can be inserted so as to prevent the lockable post from being removed from the post access slot.

In some embodiments, the storage section includes a zipper assembly, the zipper assembly including a zipper tab, the zipper tab having a zipper tab hole for receiving a lockable post, the lockable post having a lock hole through which a lock can be inserted so as to prevent the lockable post from being removed from the zipper tab hole.

In some embodiments, the hook section includes: a locking device capable of locking the hook section closed and locking the zipper assembly closed so that the hook section cannot be easily removed from the closet rod and so that the zipper assembly cannot be opened without use of a key or combination. In further embodiments, the locking device includes: a hinged locking plate having a lockable post; and a post access slot through the hook section for receiving the lockable post, wherein the zipper assembly includes: a zipper tab having a zipper tab hole for receiving the lockable post, and wherein the lockable post has a lock hole through which a lock can be inserted so as to prevent the lockable post from being removed from the post access slot, and to prevent the lockable post from being removed from the zipper tab hole.

Another general aspect of the invention is a hanging jewelry safe for storing valuables, the hanging jewelry safe including: means for storing, substantially similar in appearance to a conventional garment bag, the means for storing including a first storage side and a second storage side, the first storage side and second storage side being connected in bi-folded relationship such that from a folded, zipped, and locked configuration, the storage section can be unlocked, unzipped, and unfolded into an opened configuration so as to reveal the contents of each storage side; and means for hooking, securely attached to the means for storing, the means for hooking being capable of hanging from a closet rod, and being lockable onto the closet rod so as to prevent removal of the means for hooking from the closet rod when the means for hooking is locked.

In some embodiments, the means for storing includes at least one of: pockets, pouches, and loops for storing jewelry and other valuables.

In some embodiments, the second storage side includes: second means for hooking also being for supporting the second storage side from the closet rod when the means for storing has been unfolded into the opened configuration.

In some embodiments, the means for hooking that is securely attached to the means for storing is also rotatably attached to the means for storing.

In some embodiments, the means for hooking includes: means for locking closed the means for hooking so that the means for hooking cannot be easily removed from the closet rod without use of a key or combination. In further embodiments, the means for locking includes a hinged locking plate having a lockable post, and a post access slot through the means for hooking being for receiving the lockable post, the lockable post having a lock hole through which a lock can be inserted so as to prevent the lockable post from being removed from the post access slot.

In some embodiments, the means for storing includes a zipper means, the zipper means including a zipper tab, the zipper tab having a zipper tab hole for receiving a lockable post, the lockable post having a lock hole through which a lock can be inserted so as to prevent the lockable post from being removed from the zipper tab hole.

In some embodiments, the means for hooking includes: means for locking closed the means for hooking, and locking closed the zipper means so that the means for hooking cannot be easily removed from the closet rod, and so that the zipper means cannot be opened without use of a key or combination. In further embodiments, the means for locking includes: a hinged locking plate having a lockable post; and a post access slot through the means for hooking being for receiving the lockable post, wherein the zipper means includes: a zipper tab having a zipper tab hole for receiving the lockable post, and wherein the lockable post has a lock hole through which a lock can be inserted so as to prevent the lockable post from being removed from the post access slot, and to prevent the lockable post from being removed from the zipper tab hole.

Another general aspect of the invention is a method of making a hanging jewelry safe disguised as a garment bag. The method includes providing a storage section that resembles a typical garment bag, the storage section including a first storage side, a second storage side, and a gusset connecting the first storage side to the second storage side, the gusset being operable to allow the second storage side to fold over the first storage side into a closed configuration, and being operable to allow the first and second storage sides to unfold into an open configuration; providing the storage section with a zipper for sealing the hanging jewelry safe when in the closed configuration by joining the first storage side to the second storage side; and affixing a plurality of jewelry-holding compartments within the storage section.

The hanging safe of the invention enables valuables such as jewelry to be secured within what appears to be a typical garment bag that can hang inside of a clothes closet, for example. The hanging jewelry safe can be closed and locked so that it is difficult to open to be searched. The hanging jewelry safe of the invention cannot be easily removed from the rod upon which it hangs in the closet. The hanging jewelry safe of the invention has convenient receptacles for placing and organizing jewelry and other valuables in various locations throughout the safe for easy access by the user. The hanging jewelry safe of the invention can be securely hung in a closed configuration from a closet rod in a closet, and can be opened and hung in an opened configuration for easy access to the contents of the safe, without removing the safe from the closet rod.

### BRIEF DESCRIPTION OF THE DRAWING FIGURES

The invention will be more fully understood by reference to the detailed description, in conjunction with the following figures, wherein:

FIG. 1 depicts a front view of various types of hanging storage devices of the prior art hanging on a closet rod, along with an embodiment of the hanging jewelry safe of the invention.

FIG. 2A is a perspective view of an upper portion of an embodiment of the hanging jewelry safe of the invention hanging on a closet rod in a rotational orientation so as to resemble how a typical garment bag hangs on the closet rod so as not to take up space along the closet rod.

FIG. 2B is a perspective view of the hanging jewelry safe of FIG. 2A, in a rotational orientation so as to facilitate opening the hanging jewelry safe, and then easy access to the contents of the hanging jewelry safe.

FIG. 2C is a close-up perspective view of the hook portion of an embodiment of the hanging jewelry safe of the invention hanging on a closet rod.

FIG. 3A is a frontal view of an embodiment of the hanging jewelry safe of the invention in an open configuration.

FIG. 3B is a close up view of a secondary hook portion of an embodiment of the hanging jewelry safe of the invention.

FIG. 4 is a close-up view of one of the sides of the hanging jewelry safe of the invention, showing some of the storage compartments therein.

FIG. 5 is a flowchart illustrating a method of using an embodiment of the hanging jewelry safe of the invention.

### DETAILED DESCRIPTION

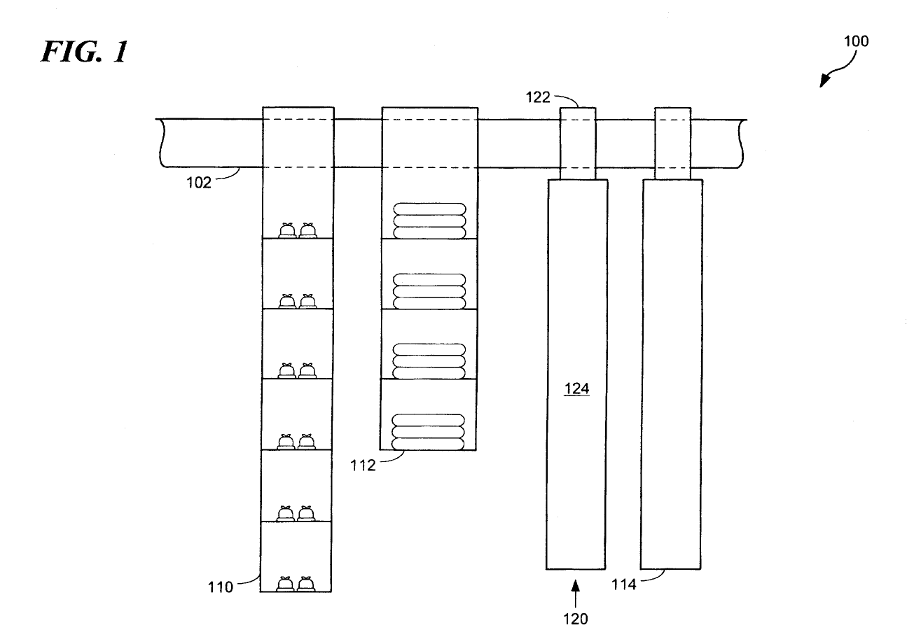

Referring to FIG. 1, various storage devices may be found and used in a closet, suspendable from a closet rod 102 that is typically used for suspending clothing from hangers. One example is a shoe organizer 110, which utilizes a conventional method in which several pairs of shoes may be hung in a successive vertical array constructor from fabric or other material. Another example is an apparel organizer 112, in which several successive vertical compartments are available for stacking various items of apparel which may be folded and placed on a shelf like platforms in the apparel organizer.

Also in FIG. 1 can be seen a typical garment bag 114, used for protectively holding a suit, dress, or other garment. Next to it can be seen an embodiment of the hanging jewelry safe 120 of the invention, which hangs from the closet rod 102 by a secure hook 122, and has a storage section 124 for storing jewelry and other valuables. Seen from the outside, the hanging jewelry safe 120 of the invention substantially resembles the typical garment bag 114.

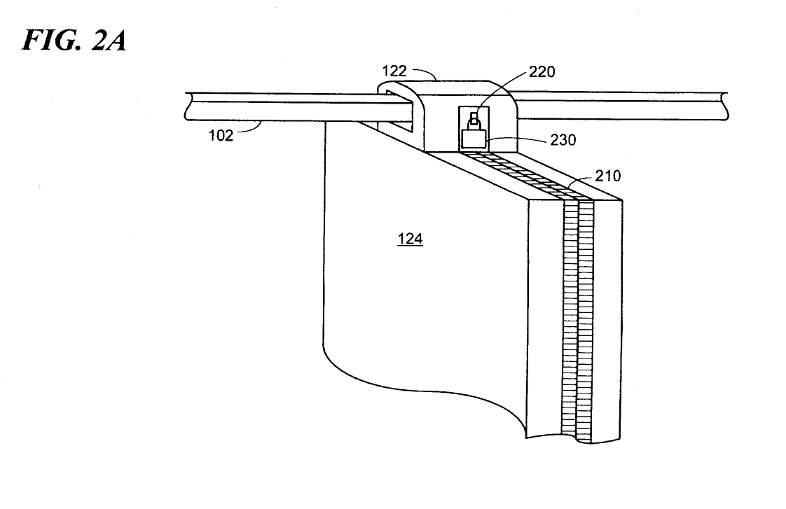

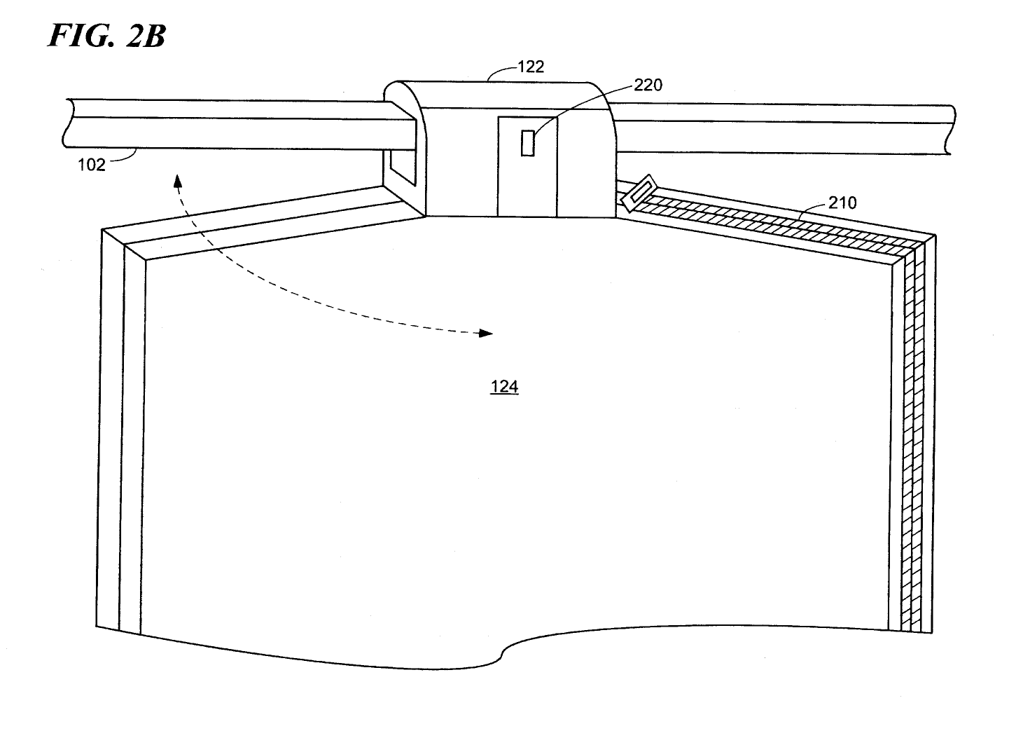

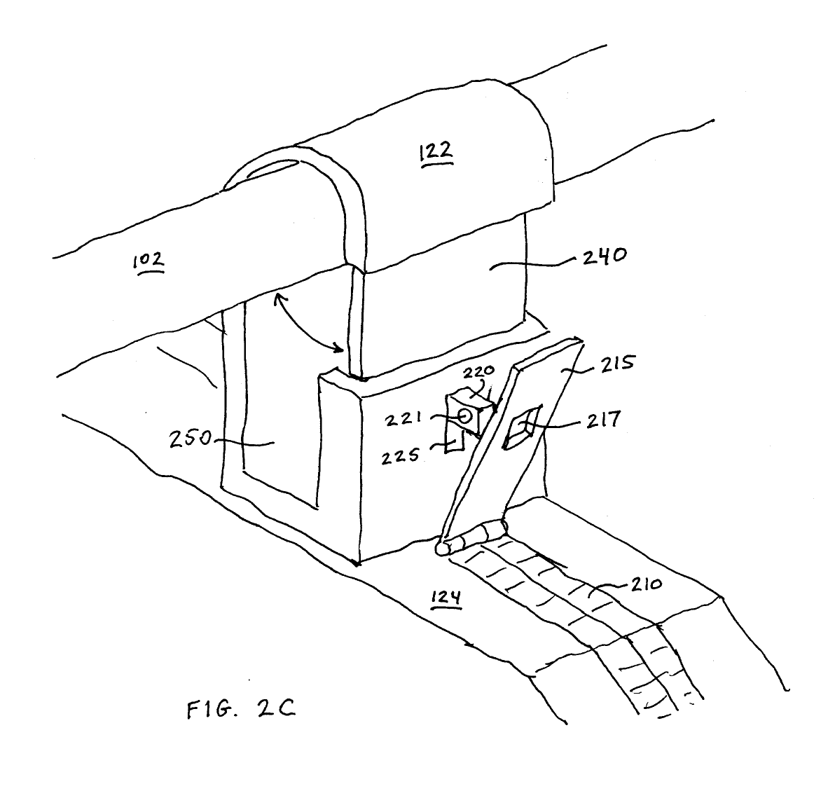

Referring to FIG. 2A, the hanging jewelry safe 120 can be suspended in a storage configuration from the closet rod 102 by the secure hook 122 that may be held securely on the closet rod 102 by a padlock 230 or other locking device. The storage section 124 of the hanging jewelry safe 120 may be opened or closed by securing means, for example by a zipper 210 opened and closed by means of a zipper pull 215. In other possible embodiments, lockable clasps, straps, or other securing means may be used to keep the hanging jewelry safe closed.

Referring to FIG. 2B, the storage section 124 of the hanging jewelry safe 120 is shown rotated before being opened. It can be seen that the storage section 124 is rotatably affixed to the secure hook 122.

FIG. 2C shows a possible embodiment the secure hook 122 section in more detail. The secure hook 122 may be rotatably secured to the storage section 124 by a connecting swivel or barrel (not shown) in such fashion that the storage section 124 is not easily detachable from the secure hook 122. The zipper pull tab 215 of the zipper 210 has a hole through it. A lockable post 220, having a lock hole 221 through it, may be sized to fit through a post access slot 225 that may pass through a bottom portion of the secure hook 122. The lockable post 220 may be integral with or securely fastened to a latch plate 240 that may be rotatably attached to the secure hook 122 by a hinge device (not shown).

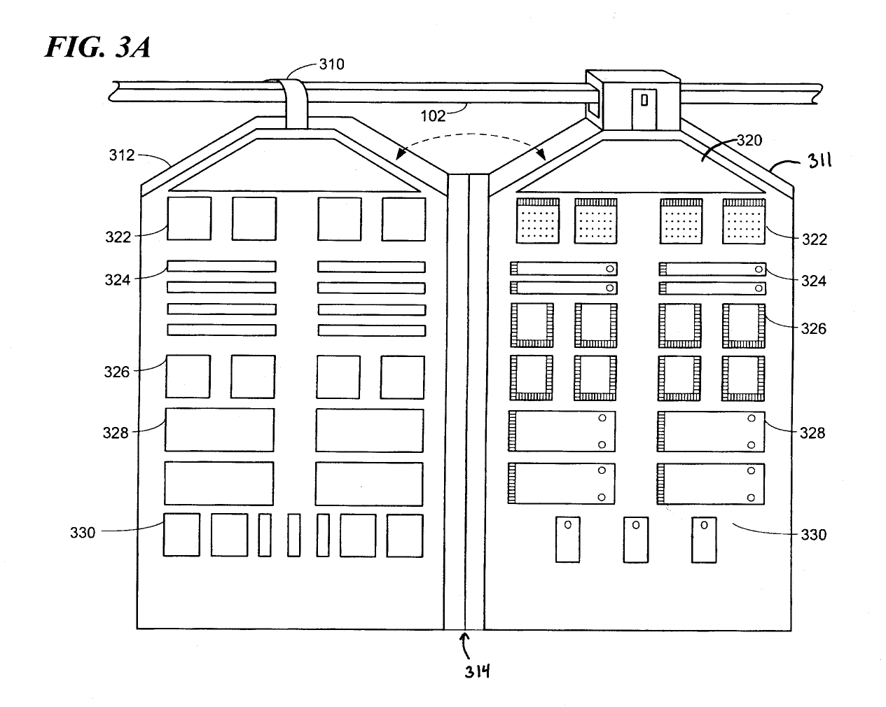

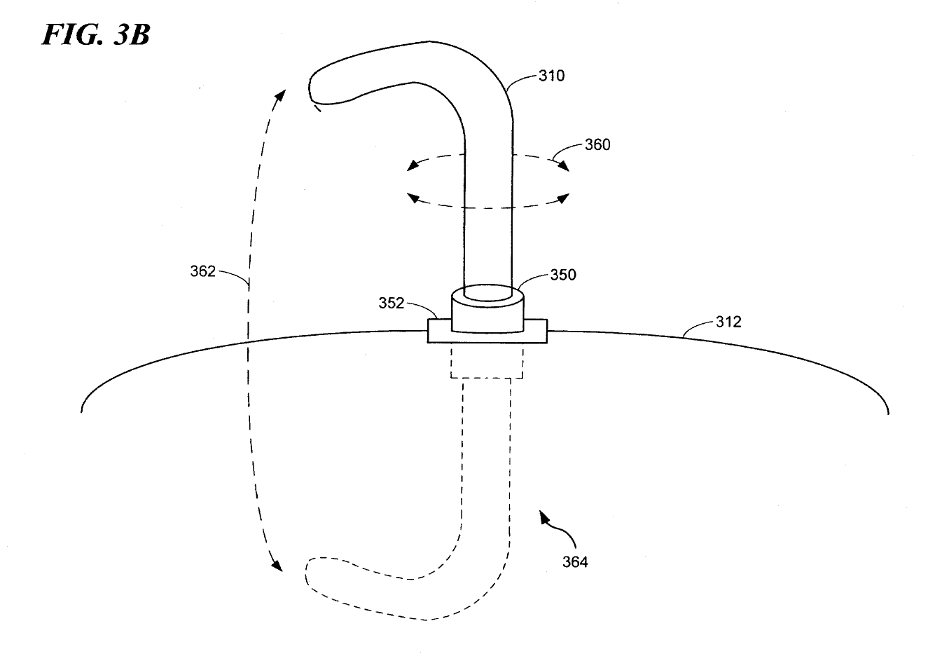

Referring to FIG. 3A, the hanging jewelry safe 120 is shown in an open configuration. A first storage side 311 of the storage section 124 remains secured to the closet rod 102 by the secure hook 122. A second storage side 312 of the storage section 124 may be supported from the closet rod 102 by a secondary hook 310.

Ideally, the closet rod 102 should be supported by a set of closet flanges (not shown) (or other closet rod mounting system) that cannot be easily removed from the walls of the closet, and also the closet flanges should not allow quick or easy removal of the closet rod 102 from the closet flanges. For example, the screws that secure the closet rod 102 to the walls of the closet can be tamper-resistant one-way screws that can be screwed inward to secure the closet flange but cannot be unscrewed with a standard screw driver. The more difficult it is to remove the closet rod 102 from the walls of the closet, the less likely a thief will abscond with the safe 120 and its contents.

The first storage side 311 and the second storage side 312 may be connected by a gusset 314 between them that allows the two storage sides 311, 312 of the storage section 124 to fold over one upon the other. The first and second storage sites 311, 312 may be substantially rectangular in shape as necessary to mimic the shape of a conventional garment storage bag that may be hung in a closet. Of course, “substantially rectangular” as used here includes deviations from a strict rectangular shape, such as a tapered semi-triangular shape to mimic the shape of a typical clothes hanger, such as is shown in FIG. 3A.

The gusset 314 may be a separate piece of fabric or other flexible material, or a hinged metal unit or other rigid material fitted with a hinging device, that is sewn, riveted, bolted, screwed, or otherwise secured to the two storage sides 311, 312, respectively. The gusset 314 may also be a weave or other material by which the two storage sides 311, 312 are flexibly sewn together. Alternatively, the first and second storage sides 311, 312 may be formed from a single piece of material, in which case the gusset 314 may be considered to be a common area between the two sides that is flexible enough for the two storage sides 311, 312 to fold over one upon the other.

Mirrors 320 may be secured to the first and second storage sections. Various jewelry holding compartments can be affixed to the first and second storage sections, for example apparatus for earring-holding apparatus 322, ring-holding apparatus 324, pouches 326, which may be transparent, for holding small items, bracelet-holding apparatus 328, and necklace-holding apparatus 330.

Referring to FIG. 3B, the secondary hook 310 may be multi-rotatably affixed to the top of a second storage side 312 of the storage section 124. The secondary hook 310 can be vertically rotated 362 about a horizontal axis pivot 352 to a downward position 364 to be out of the way for when the storage section 124 is closed, and can be vertically rotated 362 upward and rotated horizontally 360 about a vertical axis pivot 350 in order to more easily hang on the closet rod 102.

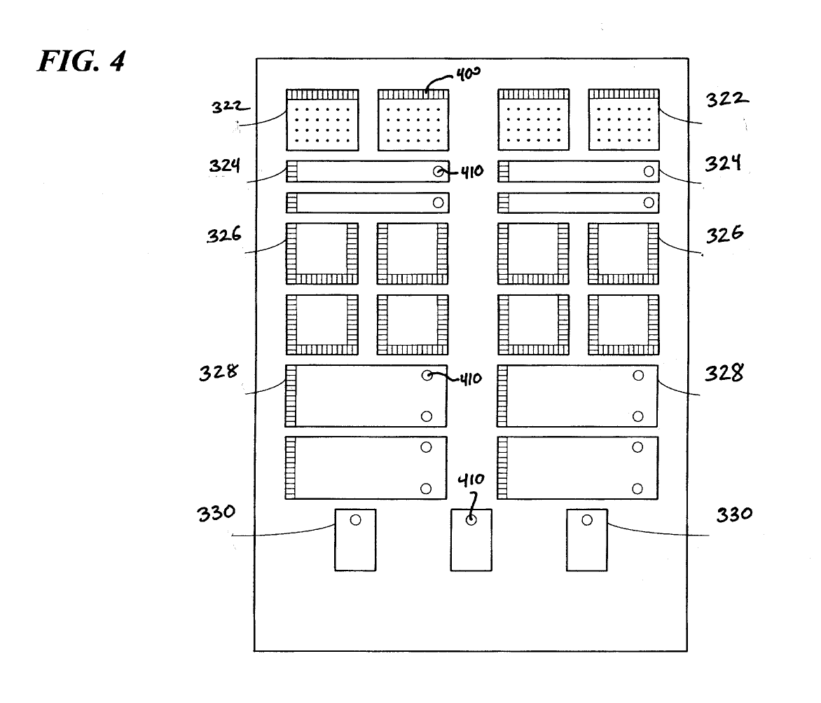

Referring to FIG. 4, a close-up of the various storage apparatus that may be used on either the first and/or second sides of the storage section 124 is seen. In these drawings, hash lines represent areas where material of the various apparatus are secured by, for example, sewing or stitching 400, to the side of the storage section 124. (In this description we will assume sewing or stitching is a method used to secure the various apparatus, but other methods of affixing, for example bonding, riveting, etc. may be used. In the disclosed embodiment fabric, plastic, or leather pieces may be discussed as being used for the various straps, flaps, or other configurations of the storage apparatus, but other suitable materials may be used as well. Some possible apparatus will now be discussed.

A flap of leather or other material acting as an earring-holding apparatus 322 may be stitched at its top to the storage section 124 and hang down therefrom. Holes in the material may act as stud holes for inserting earrings. A strap of leather or other material acting as a ring-holding apparatus 324 may be stitched on one side to the storage section 124. Rings may be placed onto the strap in order to hold them, and the other side of the strap removably secured, for example by a snap, to the storage section 124 to keep the rings secure and in place.

Pouches 326 can be sewn onto the storage section 124 with stitching on three sides, but with the top open, so that small valuables and other items can be placed into the pouches for storage. In some embodiments the material used may be plastic or other transparent material, so that the nature of the items placed therein can be ascertained by the user.

Larger straps 328 acting as bracelet-holding and/or wristwatch-holding apparatus may be sewn onto the storage section 124 in a way similar to that of the ring-holding apparatus 324, but correspondingly larger. Additional snaps may be used because of the larger size of the straps. Vertically oriented strap-hooks 430, for example strong leather or fabric loops, may be used for holding necklaces. In the embodiment illustrated in FIGS. 3A and 4, the strap-hooks 430 are loops that start and are secured (by steps, for instance) at the top, so that the bottom of the loop access a strap-hook to hold necklaces or other similarly sized and shaped items. Preferably, the storage section 124 extends far enough below the strap-hooks 430 so that the necklaces, etc. have room to hang.

The possible functions and usage of the various embodiments of the invention can be more easily understood in light of the following discussion.

FIG. 1 shows the hanging jewelry safe 120 and a conventional garment bag 114 hanging side-by-side. These two examples are both readily recognized for their storage functions when viewed within a closet. Unlike the conventional examples however, it is not readily apparently that the hanging jewelry safe 120 is anything other than just another garment bag 114. This provides a first level of security in that it is not readily apparent that the hanging jewelry safe 120 contains any valuables, so someone rummaging through the closet will likely assume that it contains only one or more articles of clothing.

Referring to FIGS. 2A and 2B, the hanging jewelry safe 120 can hang from the closet rod 102 like any ordinary garment bag 114. Referring to FIG. 2C, to place the secure hook 122 of the hanging jewelry safe 120 onto the closet rod 102, the latch plate 240 with lockable post 220 is rotatably attached to the secure hook 122 by either a free-hanging hinge or a spring-loaded hinge assembly.

Referring to FIG. 2C, to place the secure hook 122 onto the closet rod 102, the latch plate 240 is pushed inward so that it rotates up toward the top of the secure hook 122, thereby allowing the user to move the secure hook 122 over the closet rod 102 so that it is under the latch plate 240. Then the user can raise the hanging jewelry safe 120 upward so that the closet rod 102 is in a lower cavity 250 of the secure hook 122, in which position the latch plate 240 can be rotated back downward (assuming a spring-loaded hinge assembly is used the latch plate 240 will conveniently snap into place) so that the lockable post 220 attached to the latch plate 240 can pass through the post access slot 225. Then the hanging jewelry safe 120 can be lowered so that the secure hook 122 is resting on and is supported by the closet rod 102.

Once the secure hook 122 is correctly hanging from the closet rod 102, with the lockable post 220 protruding all the way through the post access slot 225, the zipper 210 can be closed by means of the zipper tab 215, and when the zipper 210 is fully closed, the zipper tab 215 can be positioned so that the lockable post 220 passes through the zipper tab hole 217 in the zipper tab 215. In this position, the padlock 230 can be passed through the lock hole 210 in the lockable post 220 and locked, thereby securely capturing both the latch plate 240 and the zipper tab 215. This embodiment utilizing a padlock 230 is one way to anchor and lock the hanging jewelry safe 120. Once the lockable post 220 is locked, the hanging jewelry safe 120 cannot be removed from the closet rod 102 and the zipper 210 cannot be opened, and as a result, the contents of the hanging jewelry safe 120 cannot be examined without unlocking the padlock 230.

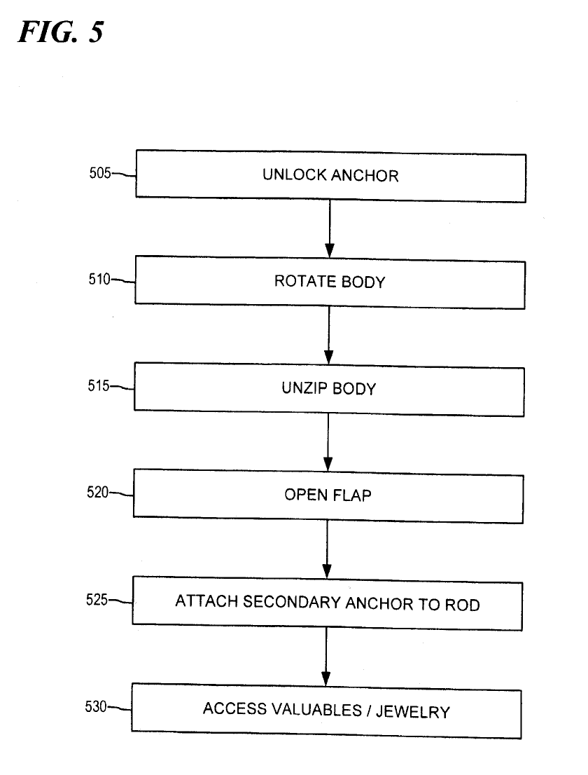

Not only is security provided by the hanging jewelry safe 120, embodiments of the hanging jewelry safe 120 provide convenience of use as well. For example, the hanging jewelry safe 120 can be opened and its contents examined and accessed even while it is still supported by the closet rod 102, by a general method outlined in FIG. 5. To show an example of how this can be done, first the secure hook 122 is unlocked 505, which in the illustrated embodiment would be performed by unlocking the padlock 230 and removing the zipper tab 215 from the lockable post 220. Then the storage section 124 may be rotated 510 by rotating it relative to the secure hook 122 for examination, for instance as shown in FIG. 2B. Then the zipper 210 can be unzipped 515 and then the storage section 124 can be opened 520, as shown in FIG. 3A for instance. Once in this position, with reference to FIG. 3B, the secondary hook 310, which hangs down from the top of the second storage side 312 while the hanging jewelry safe 120 is closed, can be attached 525 to the closet rod 102 as follows. The secondary hook 310 can be rotated upward around the horizontal axis pivot 352 and then rotated around the vertical axis pivot 350, so that it can engage the closet rod 102 to support the second storage side 312, so that the entire interior of the hanging jewelry safe 120 can be examined and accessed 530, as shown in FIG. 3A for instance.

FIGS. 3A and 4 show one possible embodiment and arrangements for various apparatus for storing different types of valuables, as previously described.

Another benefit of the hanging jewelry safe 120 is that not only can it be used to securely hide and store valuable items in a closet, it is also portable and since it looks outwardly like a typical garment bag, it could even be used to transport valuables while traveling and can be easily overlooked by baggage handlers and others who are illicitly searching for valuables in checked luggage, moving trucks, automobile trunks, etc.

Various materials can be used for the various parts of the invention. For example, any or all of the secure hook 122, zipper tab 215, lockable post 220, etc. can be made of a sturdy metal, such as steel or brass, but alternate embodiments are possible in which sturdy fabric, leather, etc. may be used to construct these parts. Similarly, the various valuable-holding apparatuses can be made of various types of flexible and/or rigid materials including leather, fabric, plastics, and even metal.

Other modifications and implementations will occur to those skilled in the art without departing from the spirit and the scope of the invention as claimed. Accordingly, the above description is not intended to limit the invention except as indicated in the following claims.

What is claimed is:

1. A hanging jewelry safe for storing valuables, the hanging jewelry safe comprising:
a storage section substantially similar in appearance to a conventional garment bag, the storage section including a first storage side and a second storage side, the first storage side and second storage side being connected in bi-folded relationship such that from a folded, zipped, and locked configuration, the storage section can be unlocked, unzipped, and unfolded into an opened configuration so as to reveal the contents of each storage side; and
a hook section, securely attached to the storage section, the hook section being capable of hanging from a closet rod, and being lockable onto the closet rod so as to prevent removal of the hook section from the closet rod when the hook section is locked.

2. The hanging jewelry safe of claim 1, wherein the storage section includes at least one of:
pockets, pouches, and loops for storing jewelry and other valuables.

3. The hanging jewelry safe of claim 1, wherein the second storage side includes:
a hook for supporting the second storage side from the closet rod when the storage section has been unfolded into the opened configuration.

4. The hanging jewelry safe of claim 1, wherein the hook section that is securely attached to the storage section is also rotatably attached to the storage section.

5. The hanging jewelry safe of claim 1, wherein the hook section includes:
a locking device capable of locking the hook section closed so that the hook section cannot be easily removed from the closet rod without use of a key or combination.

6. The hanging jewelry safe of claim 5, wherein the locking device includes a hinged locking plate having a lockable post, and a post access slot through the hook section for receiving the lockable post, the lockable post having a lock hole through which a lock can be inserted so as to prevent the lockable post from being removed from the post access slot.

7. The hanging jewelry safe of claim 1, wherein the storage section includes a zipper assembly, the zipper assembly including a zipper tab, the zipper tab having a zipper tab hole for receiving a lockable post, the lockable post having a lock hole through which a lock can be inserted so as to prevent the lockable post from being removed from the zipper tab hole.

8. The hanging jewelry safe of claim 1, wherein the hook section includes:
a locking device capable of locking the hook section closed and locking the zipper assembly closed so that the hook section cannot be easily removed from the closet rod and so that the zipper assembly cannot be opened without use of a key or combination.

9. The hanging jewelry safe of claim 8, wherein the locking device includes:
a hinged locking plate having a lockable post; and
a post access slot through the hook section for receiving the lockable post,
wherein the zipper assembly includes:
a zipper tab having a zipper tab hole for receiving the lockable post,
and wherein the lockable post has a lock hole through which a lock can be inserted so as to prevent the lockable post from being removed from the post access slot, and to prevent the lockable post from being removed from the zipper tab hole.

10. The hanging jewelry safe of claim 3, wherein the hook is rotatably coupled to the second storage side such that it is rotatable about two axes.

11. A hanging jewelry safe for storing valuables, the hanging jewelry safe comprising:
means for storing, substantially similar in appearance to a conventional garment bag, the means for storing including a first storage side and a second storage side, the first storage side and second storage side being connected in bi-folded relationship such that from a folded, zipped, and locked configuration, the storage section can be unlocked, unzipped, and unfolded into an opened configuration so as to reveal the contents of each storage side; and
means for hooking, securely attached to the means for storing, the means for hooking being capable of hanging from a closet rod, and being lockable onto the closet rod so as to prevent removal of the means for hooking from the closet rod when the means for hooking is locked.

12. The hanging jewelry safe of claim 11, wherein the means for storing includes at least one of:
pockets, pouches, and loops for storing jewelry and other valuables.

13. The hanging jewelry safe of claim 11, wherein the second storage side includes:
second means for hooking also being for supporting the second storage side from the closet rod when the means for storing has been unfolded into the opened configuration.

14. The hanging jewelry safe of claim 11, wherein the means for hooking that is securely attached to the means for storing is also rotatably attached to the means for storing.

15. The hanging jewelry safe of claim 11, wherein the means for hooking includes:
means for locking closed the means for hooking so that the means for hooking cannot be easily removed from the closet rod without use of a key or combination.

16. The hanging jewelry safe of claim 15, wherein the means for locking includes a hinged locking plate having a lockable post, and a post access slot through the means for hooking being for receiving the lockable post, the lockable post having a lock hole through which a lock can be inserted so as to prevent the lockable post from being removed from the post access slot.

17. The hanging jewelry safe of claim 11, wherein the means for storing includes a zipper means, the zipper means including a zipper tab, the zipper tab having a zipper tab hole for receiving a lockable post, the lockable post having a lock hole through which a lock can be inserted so as to prevent the lockable post from being removed from the zipper tab hole.

18. The hanging jewelry safe of claim 11, wherein the means for hooking includes:
means for locking closed the means for hooking, and locking closed the zipper means so that the means for hooking cannot be easily removed from the closet rod, and so that the zipper means cannot be opened without use of a key or combination.

19. The hanging jewelry safe of claim 18, wherein the means for locking includes:
a hinged locking plate having a lockable post; and
a post access slot through the means for hooking being for receiving the lockable post,
wherein the zipper means includes:
a zipper tab having a zipper tab hole for receiving the lockable post,
and wherein the lockable post has a lock hole through which a lock can be inserted so as to prevent the lockable post from being removed from the post access slot, and to prevent the lockable post from being removed from the zipper tab hole.

20. A method of making a hanging jewelry safe disguised as a garment bag, the method comprising:
providing a storage section that resembles a typical garment bag, the storage section including a first storage side, a second storage side, and a gusset connecting the first storage side to the second storage side, the gusset being operable to allow the second storage side to fold over the first storage side into a closed configuration, and being operable to allow the first and second storage sides to unfold into an open configuration;
providing the storage section with a zipper for sealing the hanging jewelry safe when in the closed configuration by joining the first storage side to the second storage side; and
affixing a plurality of jewelry-holding compartments within the storage section.
